(19) United States
(12) Patent Application Publication
(10) Pub. No.: US 2026/0217176 A1
(43) Pub. Date: Jul. 30, 2026

(54) COLLAPSIBLE HANDLE FOR RECREATIONAL VEHICLES

(71) Applicant: MORRYDE INTERNATIONAL, INC., Elkhart, IN (US)

(72) Inventors: Ryan Mason, Niles, MI (US); Ben Kauffman, Goshen, IN (US); Michael A. Spencer, Stevensville, MI (US)

(21) Appl. No.: 19/460,780

(22) Filed: Jan. 27, 2026

Related U.S. Application Data
(60) Provisional application No. 63/750,212, filed on Jan. 27, 2025.

(51) Int. Cl. B60N 3/02

(52) U.S. Cl. CPC B60N 3/023; B60N 3/026

(57) ABSTRACT

Handles for a recreational vehicle includes a handrail and a support arm movable relative to one another and relative to the recreational vehicle to move the handle from a storage position with the handle extending along the recreation vehicle and a use position with the handrail extending outwardly from the recreational vehicle.

### CROSS-REFERENCE TO RELATED APPLICATION

This application claims the benefit of priority to U.S. Provisional Application No. 63/750,212, filed January 27, 2025, which is hereby incorporated by reference herein in its entirety.

### FIELD OF THE DISCLOSURE

The present disclosure generally relates to handles for recreational vehicles and, more particularly, to collapsible handles for recreational vehicles.

### BACKGROUND

Recreational vehicles (“RVs”) include a variety of structures and components that require a user to climb or otherwise stand in an elevated position. For example, RVs can include staircases to reach elevated doorways, suspended gates, and so forth. In many cases, a handle would be helpful for a user to support themselves in these areas. However, a need exists for handles with improved functionality and storage configurations.

### BRIEF DESCRIPTION OF THE DRAWINGS

FIG. 1A is a perspective view of a first example collapsible handle for a recreational vehicle in a storage position relative to the recreational vehicle in accordance with various embodiments.

FIG. 1B is a sectional view of the collapsible handle of FIG. 1A showing detail of a lower pivot connection.

FIG. 1C is a perspective view of the collapsible handle of FIG. 1A in a use position.

FIG. 1D is a cross-sectional view of the collapsible handle of FIG. 1C.

FIG. 2A is a perspective view of a second example collapsible handle for a recreational vehicle in a storage position relative to the recreational vehicle in accordance with various embodiments.

FIG. 2B is a perspective view of the collapsible handle of FIG. 2A in a use position.

FIG. 2C is a cross-sectional view of the collapsible handle of FIG. 2B.

FIG. 3A is a perspective view of a third example collapsible handle for a recreational vehicle in a storage position relative to the recreational vehicle in accordance with various embodiments.

FIG. 3B is a sectional view of the collapsible handle of FIG. 3A showing detail of a lower pivot connection in a first position.

FIG. 3C is a sectional view of the collapsible handle of FIG. 3A showing detail of the lower pivot connection in a second position.

FIG. 3D is a perspective view of the collapsible handle of FIG. 3A in a use position.

FIG. 3E is a cross-sectional view of the collapsible handle of FIG. 3D.

FIG. 4A is a perspective view of a fourth example collapsible handle for a recreational vehicle in a storage position relative to the recreational vehicle in accordance with various embodiments.

FIG. 4B is a perspective view of the collapsible handle of FIG. 4A showing a handrail pivoted outwardly.

FIG. 4C is a perspective view of the collapsible handle of FIG. 4A showing the handrail and a support arm pivoted outwardly.

FIG. 4D is a perspective view of the collapsible handle of FIG. 4A in a use position.

FIG. 5A is a perspective view of a fifth example collapsible handle for a recreational vehicle in a storage position relative to the recreational vehicle in accordance with various embodiments.

FIG. 5B is a perspective view of the collapsible handle of FIG. 5A in an intermediate position.

FIG. 5C is a perspective view of the collapsible handle of FIG. 5A in a use position.

FIG. 6A is a perspective view of a sixth example collapsible handle for a recreational vehicle in a storage position relative to the recreational vehicle in accordance with various embodiments.

FIG. 6B is a perspective view of the collapsible handle of FIG. 6A showing a handrail pivoted outwardly.

FIG. 6C is a perspective view of the collapsible handle of FIG. 6A showing a support arm pivoted downwardly from the handrail.

FIG. 6D is a perspective view of the collapsible handle of FIG. 6A in a use position.

FIG. 7A is a perspective view of a seventh example collapsible handle for a recreational vehicle in a storage position relative to the recreational vehicle in accordance with various embodiments.

FIG. 7B is a perspective view of the collapsible handle of FIG. 7A showing a handrail pivoted outwardly.

FIG. 7C is a perspective view of the collapsible handle of FIG. 7A in a use position.

### DETAILED DESCRIPTION

Collapsible handles for a recreational vehicle (“RV”) is described herein that can be manipulated between a storage position with the handle stowed against the RV and a use position with a handrail of the handle extending outwardly from the RV to provide support for a user. The handles can advantageously be secured to the RV adjacent to any desired structure, such as doors, tailgates, or other elevated components where a user might need . The handles include a handrail and a support arm with ends coupled (e.g. pivotably coupled, releasably coupled, etc.) to the RV. The handrail and support arm are movable with respect to one another and relative to the RV, allowing the handrail to be pivoted from the storage position extending generally parallel to a surface of the RV and the use position.

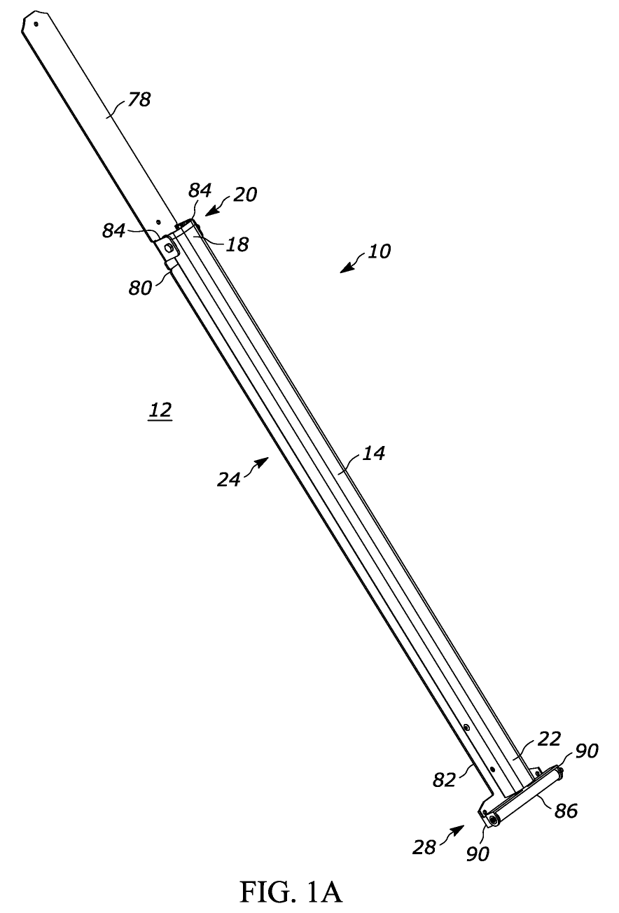

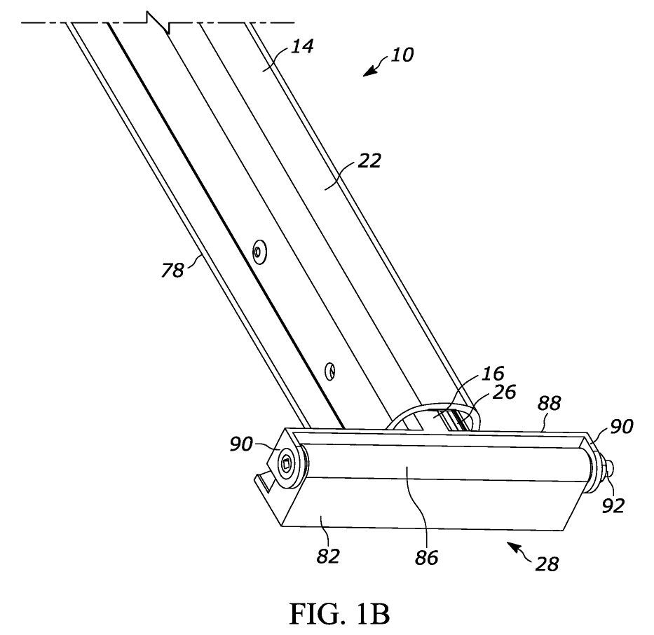

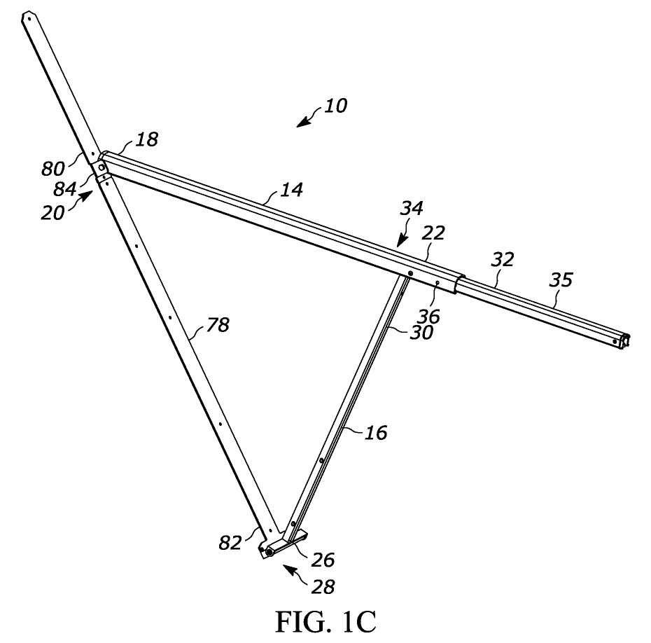

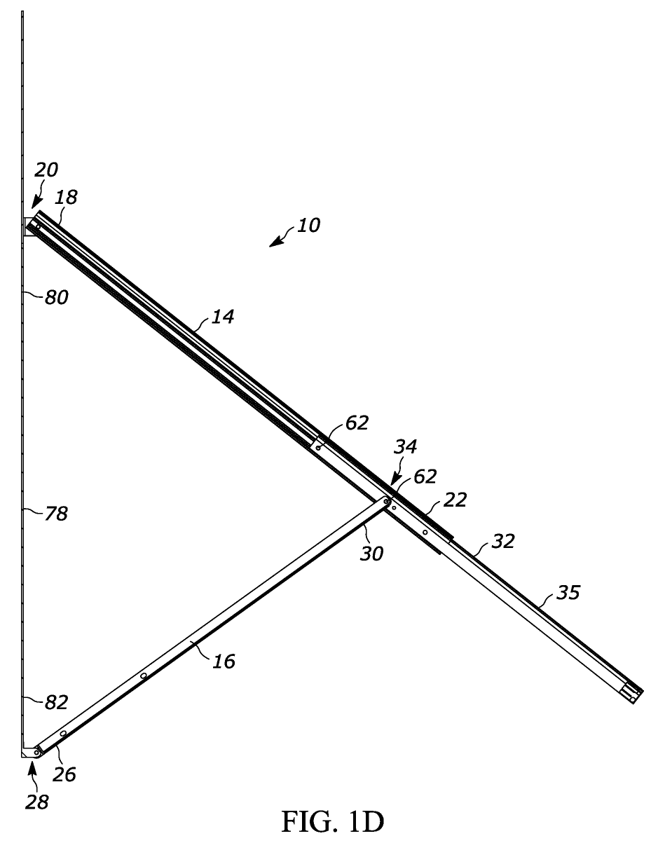

Turning now to FIGS. 1A-1D, a first example collapsible handle 10 for a RV 12 is shown that includes a handrail 14 and a support arm 16. The handrail 14 has a proximal end 18 pivotably coupled relative to the RV 12 with a first pivot connection 20 and an opposite, distal end 22. This configuration allows the handrail 14 to be pivoted about the pivot connection 20 from a storage position, as shown in FIG. 1A, to a use position, as shown in FIG. 1C. In the storage position, the handrail 14 extends parallel to or generally, e.g., between 0-5 degrees or between 0-3 degrees, parallel to a surface 24 of the RV 12 to which the handle 10 is mounted and, in the use position, the handrail 14 extends outwardly from the surface 24 of the RV 12.

The support arm 16 has a first end 26 pivotably coupled relative to the RV 12 with a second pivot connection 28 and an opposite, second end 30. As shown, the second end 30 of the support arm 16 is slidingly coupled to the handrail 14, such that the second end 30 slides along a length of the handrail 14 as the handrail 14 is pivoted between the storage and use positions. For example, the second end 30 slides toward the distal end 22 as the handrail 14 is pivoted to the use position and slides toward the proximal end 18 of the handrail 14 as the handrail 14 is pivoted to the storage position. With this configuration, the second end 30 of the support arm 16 is adjacent to the proximal end 18 of the handrail 14 in the storage position and adjacent to the distal end 22 of the handrail 14 in the use position. Further, the second end 30 of the support arm 16 can be pivotably coupled relative to the handrail 14, such that the handrail 14 and support arm 16 can be pivoted relative to one another as the handrail 14 is pivoted between the use and storage positions.

In one example, the support arm 16 can have a unitary structure, such that the support arm 16 has a single piece construction. It will be understood that a single piece construction can include components permanently attached to one another, such as by welding and the like. In another example, the support arm 16 can have a fixed length.

In the illustrated example, in order for the handrail 14 to lie flat along the RV 12 in the storage position, the first and second pivot connections 20, 28 can be spaced from one another a predetermined distance, and the handrail 14 can be sized to be less than the predetermined distance, such that the distal end 22 of handrail 14 is spaced from and disposed adjacent to the second pivot connection 28 in the storage position.

As shown in the figures, the handle 10 can further include a sliding member 32 that is coupled to the handrail 14 to slide therealong when the handrail 14 is pivoted between the storage and use position. Advantageously, the support arm 16 is pivotably coupled to the sliding member 32 with a third pivot connection 34, such that the support arm 16 is slid relative to the handrail 14 as the sliding member 32 shifts therealong.

If desired, the sliding member 32 can be utilized to provide an extended handrail length. As shown in FIG. 1, the sliding member 32 can be sized so that a distal end portion 35 thereof extends past the distal end 22 of the handrail 14 with the handrail 14 in the use position. This configuration allows the handrail 14, and thus the handle 10 as a whole, to have a compact configuration while still providing an extended support length. In one example, the sliding member 32 can be sized to be disposed within the length, i.e., not extend past the proximal or distal ends 18, 22, of the handrail 14 with the handrail 14 in the storage position, so that the handrail 14 can extend to be directly adjacent to the second pivot connection 28, maximizing the compact configuration of the handle 10.

The handrail 14 can be held in the use position and/or the storage position by any desired mechanism. In one example, the handrail 14 can frictionally engage the sliding member 32 and/or the support arm 16. In another example, the handle 10 can include a lock pin 36 that can be used to selectively engage the handrail 14 and one or both of the sliding member 32 or support arm 16 to hold the components in a desired orientation relative to one another.

The sliding member 32 can be coupled to the handrail 14 by any suitable structure. For example, the sliding member 32 and the handrail 14 can be coupled together with tongue-and-groove or other interlocking components. In the illustrated example, the handrail 14 has a tubular body with a sidewall defining an inner channel sized to receive the sliding member 32 therein, allowing the sliding member 32 to telescope relative to the handrail 14. The sliding member 32 can have a similar configuration as the handrail with a tubular body defining an inner channel and downward opening.

In one example, the handrail 14 and sliding member 32 are slidingly coupled together with a track and pin configuration, where one or more pins 62 are configured to shift within the track as the handrail 14 and sliding member 32 are moved relative to one another. Although two pins 62 are shown, additional pins 62 can be utilized if desired. Further, one set of pins 62 can advantageously be provided as a portion of the third pivot connection 34 as shown in FIG. 1C.

In any of the above, the first and second pivot connections 20, 28 can couple the handrail 14 and support arm 16 directly to structure of the RV 12, such as a wall or frame thereof. For example, the first and second pivot connections can include mounts that are configured to pivotably couple to the proximal end 18 of the handrail 14 and the first end 26 of the support arm 16 and secure to the RV 12 by any suitable mechanism, such as fasteners, welding, adhesive, and so forth.

Alternatively, as shown in the figures, the handle 10 can include a mounting bracket 78 to which the handrail 14 and support arm 16 are pivotably coupled. This allows the handle 10 to be a stand-alone component that can be easily secured in a desired location on the RV 12 while maintaining optimal spacing between the first and second pivot connections 20, 28 given the lengths of the handrail 14, support arm 16, and sliding member 32.

As shown in FIG. 1, the mounting bracket 78 can include an elongate body with a top portion 80 forming part of the first pivot connection 20 and a bottom portion 82 forming part of the second pivot connection 28. It will be understood that the handrail 14 and support arm 16 can be pivotably mounted to the mounting bracket 78 by any desired methods. Alternatively, the mounting bracket 78 can be split with the top portion 80 and the bottom portion 82 being separate components.

In the illustrated example, the first pivot connection 20 includes a pair of upstanding tabs 84 of the top portion 80 of the mounting bracket 78 that receive the proximal end 18 of the handrail 14 therebetween. A pivot member, such as a pin or rod, couples the tabs 84 to the handrail 14 allowing the handrail 14 to freely pivot relative thereto.

The bottom portion 82 of the mounting bracket 78 includes an outwardly protruding pivot mount 86 that extends perpendicular to a longitudinal length of the support arm 16. The pivot mount 86 has a width to extend past a width of the support arm 16 on one or both sides thereof. In some examples, the pivot mount 86 has a width to extend past a width of the handrail 14 on one or both sides thereof. As shown, the pivot mount 86 has an unbroken structure in the lateral direction. The first end 26 of the support arm 16 is pivotably coupled to the pivot mount 86 and, as such, includes a pronged configuration with a lateral member 88 and tabs 90 extending from ends of the lateral member 88. The tabs 90 can extend downwardly from the lateral member 88 as shown, inwardly, or upwardly to pivotably couple relative to the pivot mount 86. The lateral member 88 is sized to extend along the unbroken structure of the pivot mount 86 to position the tabs 90 at opposite ends of the pivot mount 86 to couple thereto. As shown, the pivot mount 86 can have an outwardly rounded configuration, allowing the lateral member 88 to be rotated therearound.

The second pivot connection 28 can include any suitable pivotable coupling between the pivot mount 86 of the mounting bracket 78 and the tabs 90. For example, a pivot member 92, such as a pin, rod, bolt, etc., can extend through the tabs 90 and through a throughbore defined through the pivot mount 86. In another example, the tabs 90 can include inwardly extending pivot members configured to extend into recesses or a throughbore defined in the pivot mount 86 or the pivot mount 86 can include outwardly extending pivot members configured to extend through the tabs 90.

Advantageously, the relatively larger width of the pivot mount 86 and pronged configuration of the first end 26 of the support arm 16 adds lateral bracing to the support arm 16 and, thus, the handle 10 as a whole. This configuration reduces side-to-side swaying of the handle 10 and allows the handle to provide better support for a person during use. As discussed above, although the pivot mount 86 is shown centered relative to the support arm 16, the pivot mount 86 can be partially or entirely offset relative to the support arm 16 on either side thereof, with the prong configuration of the first end 26 of the support arm 16 offset accordingly.

With this configuration, the handrail 14 is able to pivot to the storage position where the handrail 14, support arm 16, and sliding member 32 all extend generally parallel to the mounting bracket 78 and the surface of the RV 12, where the distal end 22 of the handrail 14 is disposed adjacent to and above the second pivot connection 28.

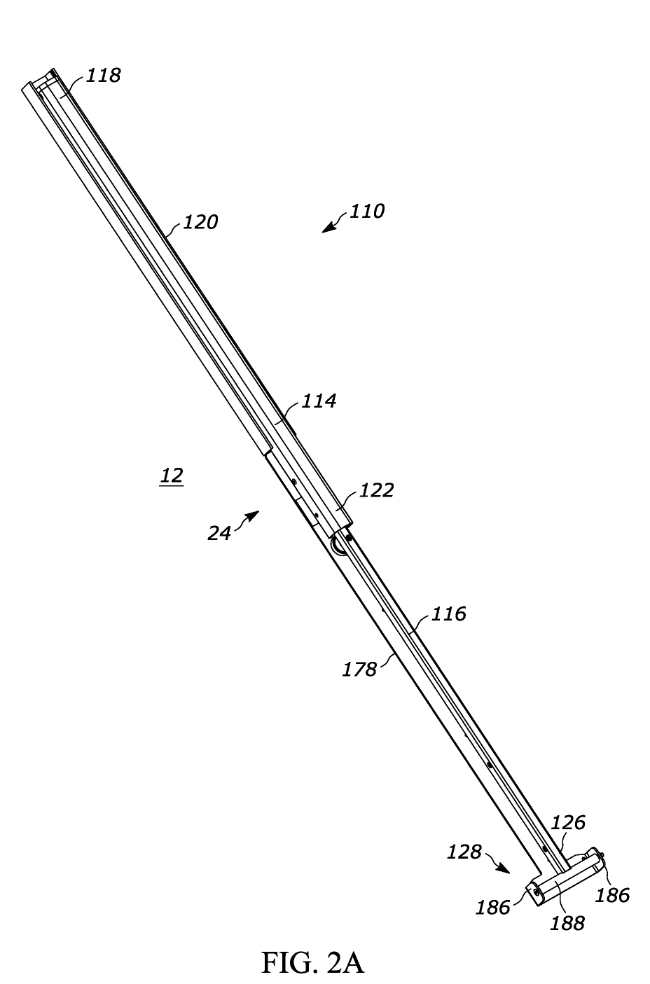

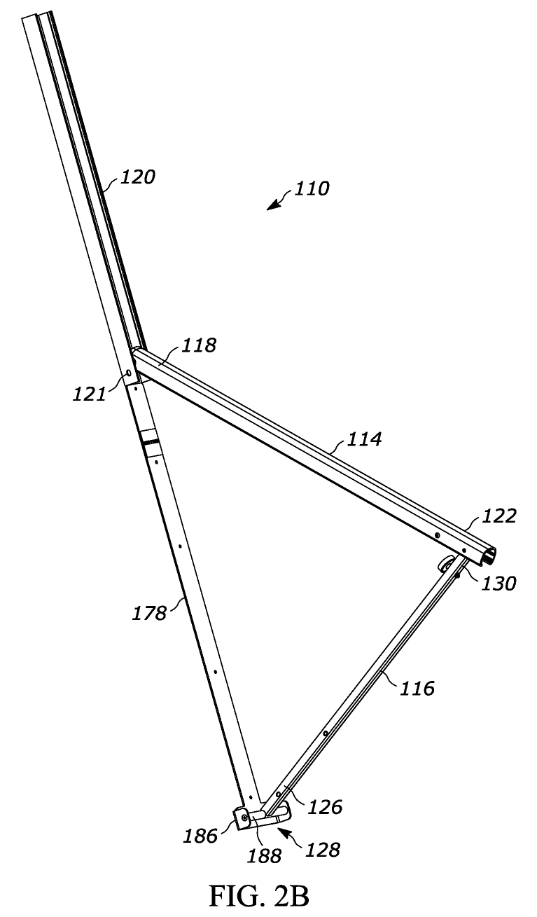

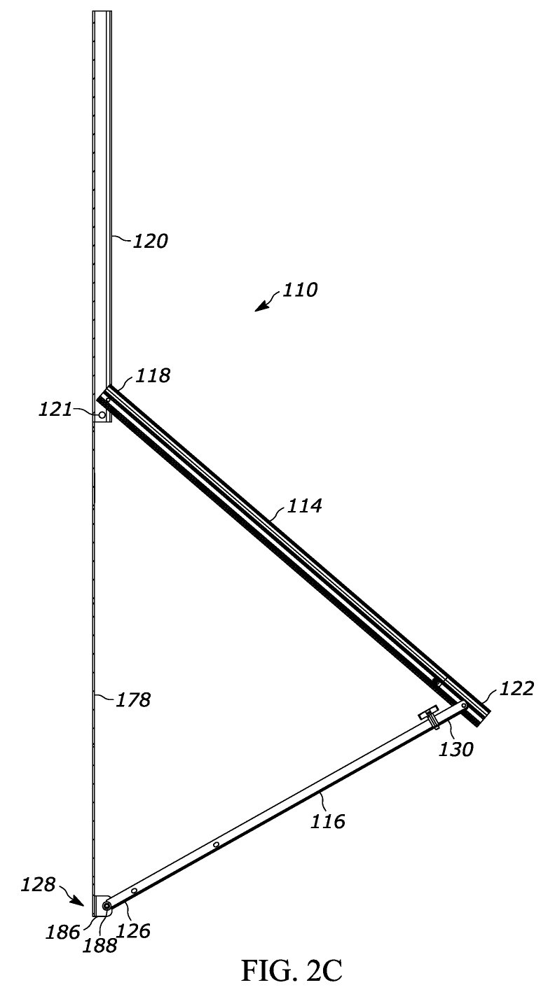

A second example collapsible handle 110 for a RV 12 is shown in FIGS. 2A-2C. The handle 110 includes a handrail 114 and a support arm 116. The handrail 114 has a proximal end 118 slidingly coupled relative to the RV 12 and an opposite, distal end 122. The support arm 116 has a first end 126 pivotably coupled relative to the RV 12 with a pivot connection 128 and an opposite, second end 130. As shown, the second end 130 of the support arm 116 and the distal end 22 of the handrail 114 are pivotably coupled together.

The handle 110 further includes a slide mounting bracket 120 that receives the proximal end 118 of the handrail 114. The slide mounting bracket 120 and handrail 114 can be coupled by any suitable configuration, including track and pin, rollers, sliders, etc. For example, the slide mounting bracket 120 can include lateral edges that define grooves sized to receive a sliding member (e.g., a pin, roller, block, etc.) therein that allows the proximal end 118 of the handrail 114 to slide upwardly and downwardly along the sliding mounting bracket 120.

This configuration allows the handrail 14 to be stored vertically above the support arm 116 as shown in FIG. 2A. When use is desired, a user can pull handrail 114, support arm 116, and/or the pivot connection 128 outwardly, which causes the proximal end 118 of the handrail 114 to slide downwardly. In one example, the slide mounting bracket 120 can define a stop 121 at a bottom thereof that the proximal end 118 of the handrail 114 abuts when in the use position. The stop 121 can be positioned to provide a desired angle for the handrail 114 during use. Alternatively, the slide mounting bracket 120 and the proximal end 118 of the handrail 114 can have a plurality of lock locations to allow a user to position the handrail 114 at a plurality of different angles. The lock locations can have any suitable configuration. For example, the slide mounting bracket 120 and the proximal end 118 of the handrail 114 can have openings that align at the lock locations to receive a lock member (e.g., a pin or bolt) therethrough, or a press fit mechanism can secure the bracket 120 and proximal end 118 frictionally together to prevent relative movement therebetween.

In any of the above, the pivot connection 128 can couple the support arm 116 directly to structure of the RV 12, such as a wall or frame thereof. For example, the pivot connection can include a mounting bracket 178 that is configured to pivotably couple to the first end 126 of the support arm 116 and secure to the RV 12 by any suitable mechanism, such as fasteners, welding, adhesive, and so forth.

The pivot connection 128 can have any suitable configuration. In the illustrated example, the mounting bracket 178 of the pivot connection 128 includes a pair of upstanding tabs 186 that receive the first end 126 of the support arm 116 therebetween. A pivot member, such as a pin or rod, couples the tabs 186 to the support arm 116 allowing the support arm 116 to freely pivot relative thereto. If desired, the first end 126 of the support arm 116 can include a bar 188 that extends laterally relative to a longitudinal length of the support arm 116 between the tabs 186. Advantageously, the added width of the bar 188 and the resulting spacing of the tabs 186 and engagement with the bar 188 adds lateral bracing to the support arm 116 and, thus, the handle 110 as a whole. This configuration reduces side-to-side swaying of the handle 110 and allows the handle to provide better support for a person during use. Although the bar 188 is shown extending laterally a generally equal distance on both sides of the support arm 116, the bar 188 can be offset on one side or extend entirely on one side of the support arm 116, as desired. Alternatively, the pivot connection 128 of this example can have a configuration as set forth in the other examples described herein.

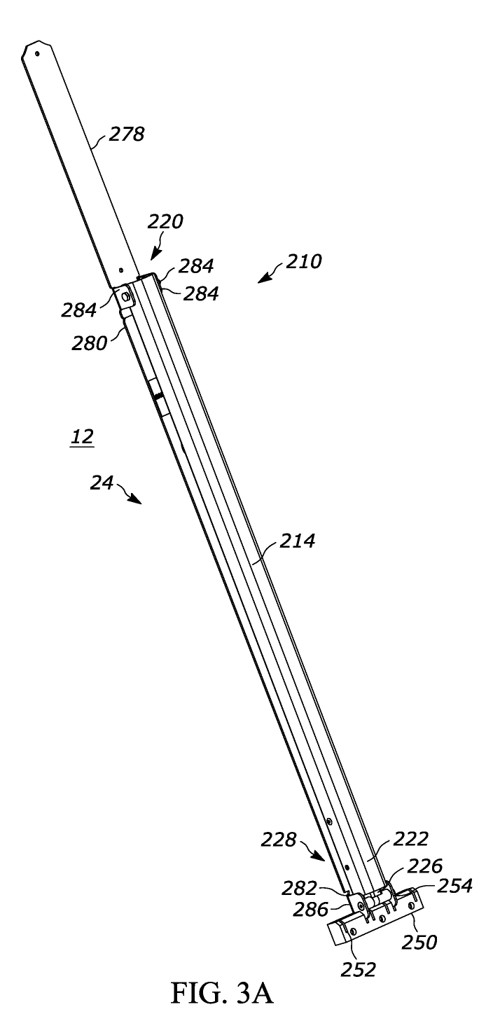

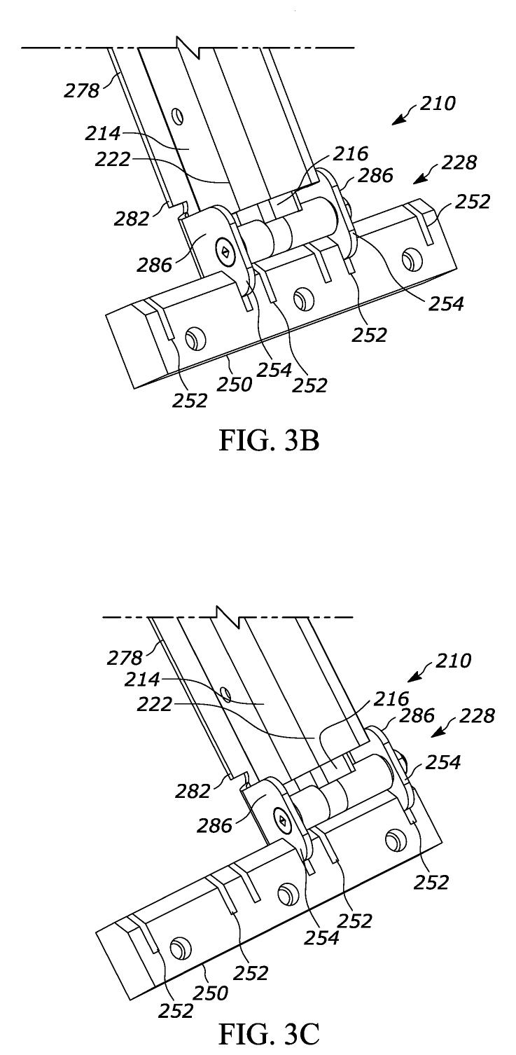

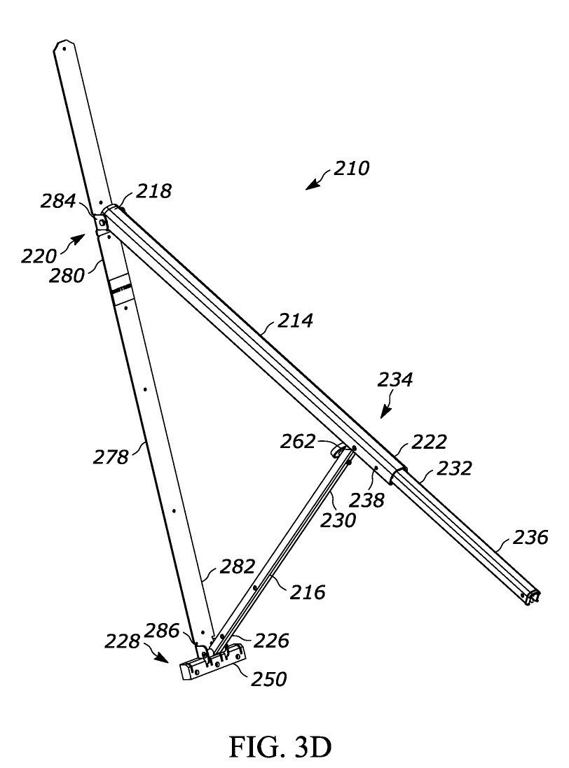

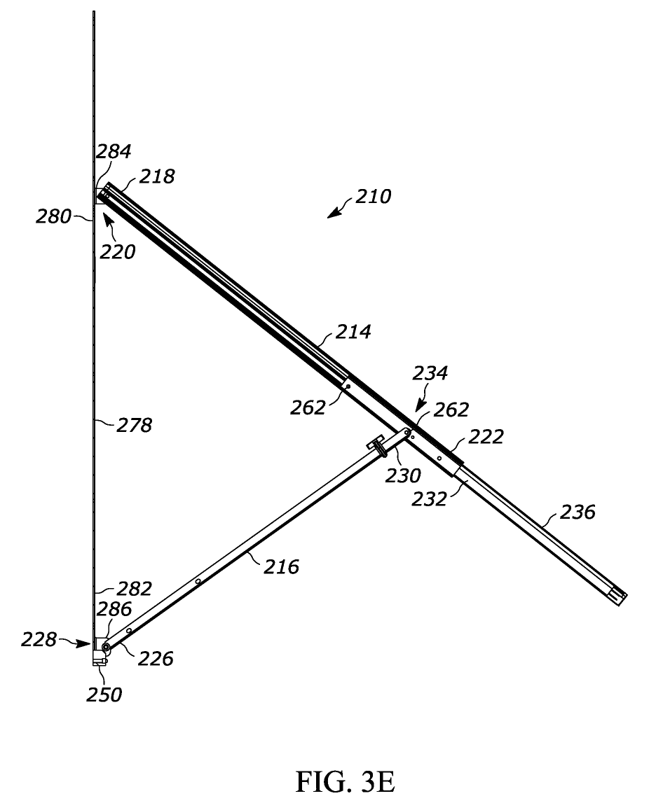

Turning now to FIGS. 3A-3E, a collapsible handle 210 for an RV 12 is shown that includes a handrail 214 and a support arm 216. The handrail 214 has a proximal end 218 pivotably coupled relative to the RV 12 with a first pivot connection 220 and an opposite, distal end 222. This configuration allows the handrail 214 to be pivoted about the pivot connection 220 from a storage position, as shown in FIG. 3A, to a use position, as shown in FIG. 3D. In the storage position, the handrail extends parallel to or generally, e.g., between 0-5 degrees or between 0-3 degrees, parallel to a surface 24 of the RV 12 to which the handle 210 is mounted and, in the use position, the handrail 214 extends outwardly from the surface 24 of the RV 12.

The support arm 216 has a first end 226 pivotably coupled relative to the RV 12 with a second pivot connection 228 and an opposite, second end 230. As shown, the second end 230 of the support arm 216 is slidingly coupled to the handrail 214, such that the second end 230 slides along a length of the handrail 214 as the handrail 214 is pivoted between the storage and use positions. For example, the second end 230 slides toward the distal end 222 as the handrail 214 is pivoted to the use position and slides toward the proximal end 218 of the handrail 214 as the handrail 214 is pivoted to the storage position. With this configuration, the second end 230 of the support arm 216 is adjacent to the proximal end 218 of the handrail 214 in the storage position and adjacent to the distal end 222 of the handrail 214 in the use position. Further, the second end 230 of the support arm 216 can be pivotably coupled relative to the handrail 214, such that the handrail 214 and support arm 216 can be pivoted relative to one another as the handrail 214 is pivoted between the use and storage positions.

In one example, the support arm 216 can have a unitary structure, such that the arm 216 has a single piece construction. It will be understood that a single piece construction can include components permanently attached to one another, such as by welding and the like. In another example, the support arm 216 can have a fixed length.

In the illustrated example, in order for the handrail 214 to lie flat along the RV 12 in the storage position, the first and second pivot connections 220, 228 can be spaced from one another a predetermined distance, and the handrail can be sized to be less than the predetermined distance, such that the distal end 222 of handrail 214 is spaced from and disposed adjacent to the second pivot connection 228 in the storage position.

As shown in the figures, the handle 210 can further include a sliding member 232 that is coupled to the handrail 214 to slide therealong when the handrail 214 is pivoted between the storage and use position. Advantageously, the support arm 216 is pivotably coupled to the sliding member 232 with a third pivot connection 234, such that the support arm 216 is slid relative to the handrail 214 as the sliding member 232 shifts therealong.

If desired, the sliding member 232 can be utilized to provide an extended handrail length. As shown in FIG. 3D, the sliding member 232 can be sized so that a distal end portion 236 thereof extends past the distal end 222 of the handrail 214 with the handrail 214 in the use position. This configuration allows the handrail 214, and thus the handle 210 as a whole, to have a compact configuration while still providing an extended support length. In one example, the sliding member 232 can be sized to be disposed within the length, i.e., not extend past the proximal or distal ends 218, 222, of the handrail 214 with the handrail 214 in the storage position, so that the handrail 214 can extend to be directly adjacent to the second pivot connection 228, maximizing the compact configuration of the handle 210.

The handrail 214 can be held in the use position and/or the storage position by any desired mechanism. In one example, the handrail 214 can frictionally engage the sliding member 232 and/or the support arm 216. In another example, the handle 210 can include a lock pin 238 that can be used to selectively engage the handrail 214 and one or both of the sliding member 232 or support arm 216 to hold the components in a desired orientation relative to one another.

The sliding member 232 can be coupled to the handrail 214 by any suitable structure. For example, the sliding member 232 and the handrail 214 can be coupled together with tongue-and-groove or other interlocking components. In the illustrated example, the handrail 214 has a tubular body with a sidewall defining an inner channel sized to receive the sliding member 232 therein, allowing the sliding member 232 to telescope relative to the handrail 214. The sliding member 232 can have a similar configuration as the handrail with a tubular body defining an inner channel and downward opening.

In one example, the handrail 214 and sliding member 232 are slidingly coupled together with a track and pin configuration, where one or more pins 262 are configured to shift within the track as the handrail 214 and sliding member 232 are moved relative to one another. Although two pins 262 are shown, additional pins 262 can be utilized if desired. One set of pins 262 can advantageously be provided as a portion of the third pivot connection 234.

In any of the above, the first and second pivot connections 220, 228 can couple the handrail 214 and support arm 216 directly to structure of the RV 12, such as a wall or frame thereof. For example, the first and second pivot connections can include mounts that are configured to pivotably couple to the proximal end 218 of the handrail 214 and the first end 226 of the support arm 216 and secure to the RV 12 by any suitable mechanism, such as fasteners, welding, adhesive, and so forth.

Alternatively, as shown in the figures, the handle 210 can include a mounting bracket 278 to which the handrail 214 and support arm 216 are pivotably coupled. This allows the handle 210 to be a stand-alone component that can be easily secured in a desired location on the RV 12 while maintaining optimal spacing between the first and second pivot connections 220, 228 given the lengths of the handrail 214, support arm 216, and sliding member 232.

As shown in FIG. 3A, the mounting bracket 278 can include an elongate body with a top portion 280 forming part of the first pivot connection 220 and a bottom portion 282 forming part of the second pivot connection 228. It will be understood that the handrail 214 and support arm 216 can be pivotably mounted to the mounting bracket 278 by any desired methods. Alternatively, the mounting bracket 278 can be split with the top portion 280 and the bottom portion 282 being separate components.

In the illustrated example, the first pivot connection 220 includes a pair of upstanding tabs 284 of the top portion 280 of the mounting bracket 278 that receive the proximal end 218 of the handrail 214 therebetween. A pivot member, such as a pin or rod, couples the tabs 284 to the handrail 214 allowing the handrail 214 to freely pivot relative thereto. The second pivot connection 228 includes a pair of upstanding tabs 286 of the bottom portion 282 of the mounting bracket 278 that receive the first end 226 of the support arm 216 therebetween. A pivot member, such as a pin or rod, couples the tabs 286 to the support arm 216 allowing the handrail 214 to freely pivot relative thereto.

As shown, the handle 210 further includes a brace 250 that is configured to be secured to the RV 12 and couple to the second pivot connection 228 to provide lateral support therefor. The brace 250 is configured to extend laterally relative to the handle 210. The brace 250 and the second pivot connection 228 include structures that are configured to interconnect. For example, the brace 250 includes openings 252 (e.g., slot openings) and the second pivot connection 228, (e.g., the tabs 286 and/or the first end 226 of the support arm 216) includes outwardly extending walls or protrusions 254 that are configured to be received within the openings 252. If desired, the brace 250 can include openings 252 to allow the second pivot connection 228 to couple thereto at a plurality of locations. For example, the second pivot connection 228 can be centered relative to the brace 250, or can be offset left and/or right relative to the brace 250. This allows the brace 250 to be secured to the RV 12 while accommodating for other structures that might be disposed adjacent to the handle 210. Of course, the brace 250 could alternatively include the walls/protrusions 254 and the second pivot connection 228 can define the openings 252. In other suitable examples, the brace 250 can engage the second pivot connection 228 in a sliding arrangement, such as with walls sliding along one another, pins and openings, and so forth. The brace 250 is configured to be releasably coupled with the second pivot connection or a bracket adjacent thereto to provide lateral bracing for the handle 210.

Advantageously, the relatively larger width provided by the brace 250 adds lateral bracing to the support arm 216 and, thus, the handle 210 as a whole. This configuration reduces side-to-side swaying of the handle 210 and allows the handle to provide better support for a person during use.

With this configuration, the handrail 214 is able to pivot to the storage position where the handrail 214, support arm 216, and sliding member 232 all extend generally parallel to the mounting bracket 278 and the surface of the RV 12, where the distal end 222 of the handrail 214 is disposed adjacent to and above the second pivot connection 228.

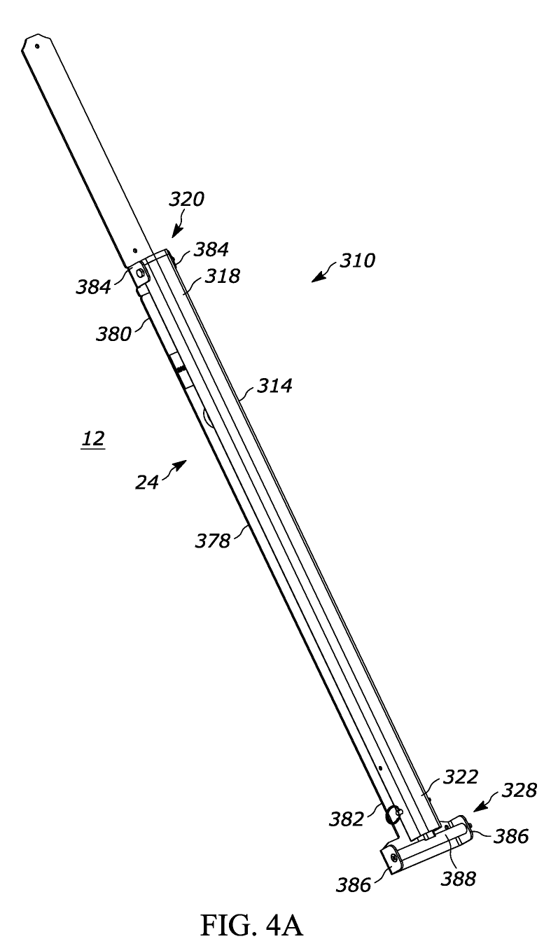

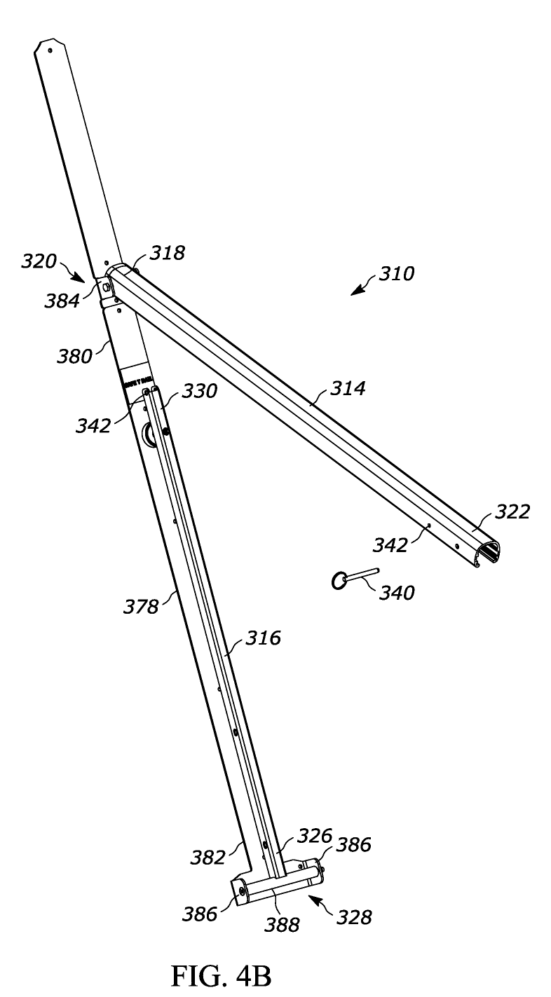

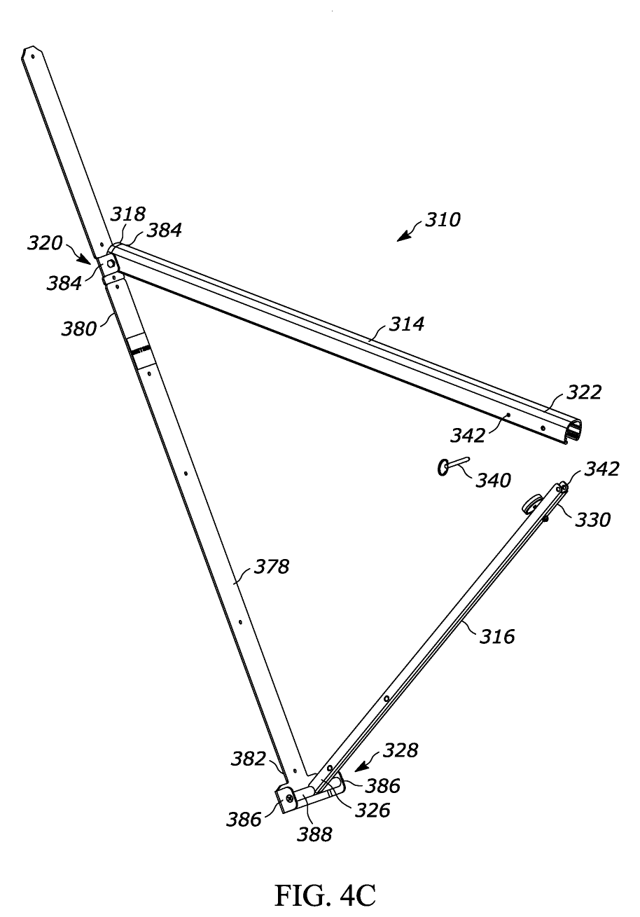

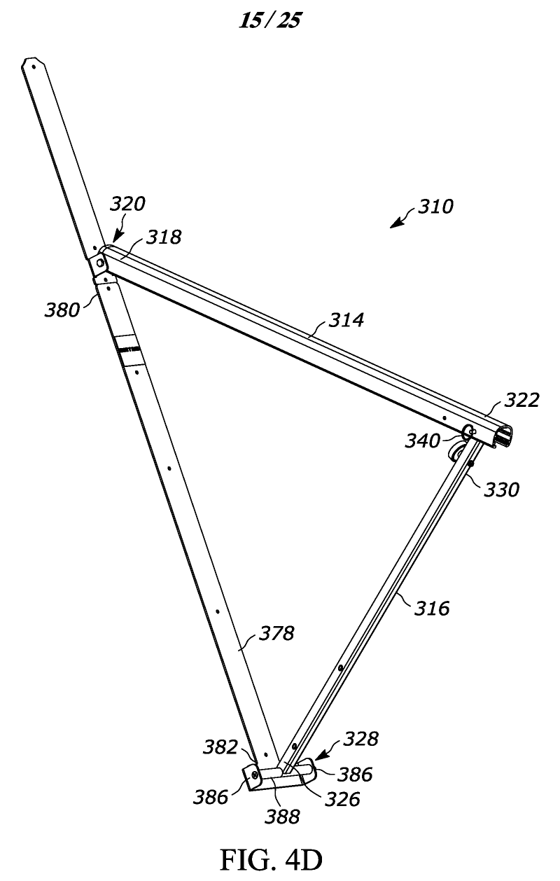

A fourth example collapsible handle 310 for an RV 12 is shown in FIGS. 4A-4D. The collapsible handle 310 includes a handrail 314 and a support arm 316. The handrail 314 has a proximal end 318 pivotably coupled relative to the RV 12 with a first pivot connection 320 and an opposite, distal end 322. This configuration allows the handrail 314 to be pivoted about the pivot connection 320 from a storage position, as shown in FIG. 4A, to a use position, as shown in FIGS. 4B-4D. In the storage position, the handrail 314 extends parallel to or generally, e.g., between 0-5 degrees or between 0-3 degrees, parallel to a surface 24 of the RV 12 to which the handle 310 is mounted and, in the use position, the handrail 314 extends outwardly from the surface 24 of the RV 12.

The support arm 316 has a first end 326 pivotably coupled relative to the RV 12 with a second pivot connection 328 and an opposite, second end 330. As shown, the second end 330 of the support arm 316 is configured to be secured to the distal end 322 of the handrail 314. For example, the handrail 314 and the support arm 316 can be pivoted to a use position where the distal end 322 of the handrail 314 is disposed adjacent to the second end 330 of the support arm 316. Thereafter, a user can secure the ends 322, 330 together to hold the handle 310 in the use position. The securing mechanism can take any suitable form, including inserting a pin 340 through aligned openings 342 defined in the ends 322, 330. Alternatively or additionally, the securing mechanism can include a clip, gravity-held coupling, a press-fit coupling, interconnecting structures, and so forth.

In the illustrated example, in order for the handrail 314 to lie flat along the RV 12 in the storage position, the first and second pivot connections 320, 328 can be spaced from one another a predetermined distance, and the handrail can be sized to be less than the predetermined distance, such that the distal end 322 of handrail 314 is spaced from and disposed adjacent to the second pivot connection 328 in the storage position.

In any of the above, the first and second pivot connections 320, 328 can couple the handrail 314 and support arm 316 directly to structure of the RV 12, such as a wall or frame thereof. For example, the first and second pivot connections can include mounts that are configured to pivotably couple to the proximal end 318 of the handrail 314 and the first end 326 of the support arm 316 and secure to the RV 12 by any suitable mechanism, such as fasteners, welding, adhesive, and so forth.

Alternatively, as shown in the figures, the handle 310 can include a mounting bracket 378 to which the handrail 314 and support arm 316 are pivotably coupled. This allows the handle 310 to be a stand-alone component that can be easily secured in a desired location on the RV 12 while maintaining optimal spacing between the first and second pivot connections 320, 328 given the lengths of the handrail 314, support arm 316, and sliding member 332.

As shown in the figures, the mounting bracket 378 can include an elongate body with a top portion 380 forming part of the first pivot connection 320 and a bottom portion 382 forming part of the second pivot connection 328. It will be understood that the handrail 314 and support arm 316 can be pivotably mounted to the mounting bracket 378 by any desired methods. Alternatively, the mounting bracket 378 can be split with the top portion 380 and the bottom portion 382 being separate components.

In the illustrated example, the first pivot connection 320 includes a pair of upstanding tabs 384 of the top portion 380 of the mounting bracket 378 that receive the proximal end 318 of the handrail 314 therebetween. A pivot member, such as a pin or rod, couples the tabs 384 to the handrail 314 allowing the handrail 314 to freely pivot relative thereto.

The second pivot connection 328 can have any suitable configuration. In the illustrated example, the bottom portion 382 of the mounting bracket 378 includes a pair of upstanding tabs 386 that receive the first end 326 of the support arm 316 therebetween. A pivot member, such as a pin or rod, couples the tabs 386 to the support arm 316 allowing the support arm 316 to freely pivot relative thereto. If desired, the first end 326 of the support arm 316 can include a bar 388 that extends laterally relative to a longitudinal length of the support arm 316 between the tabs 386. Advantageously, the added width of the bar 388 and the resulting spacing of the tabs 386 and engagement with the bar 388 adds lateral bracing to the support arm 316 and, thus, the handle 310 as a whole. This configuration reduces side-to-side swaying of the handle 310 and allows the handle to provide better support for a person during use. Although the bar 388 is shown extending laterally a generally equal distance on both sides of the support arm 316, the bar 388 can be offset on one side or extend entirely on one side of the support arm 316, as desired. Alternatively, the second pivot connection 328 of this example can have a configuration as set forth in the other examples described herein.

With this configuration, the handrail 314 is able to pivot to the storage position where the handrail 314, support arm 316, and sliding member 332 all extend generally parallel to the mounting bracket 378 and the surface 24 of the RV 12, where the distal end 322 of the handrail 314 is disposed adjacent to and above the second pivot connection 328.

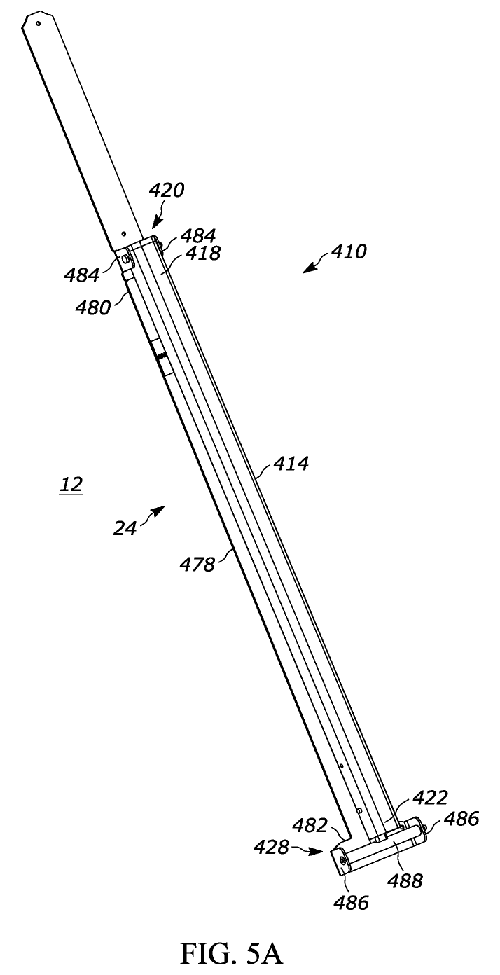

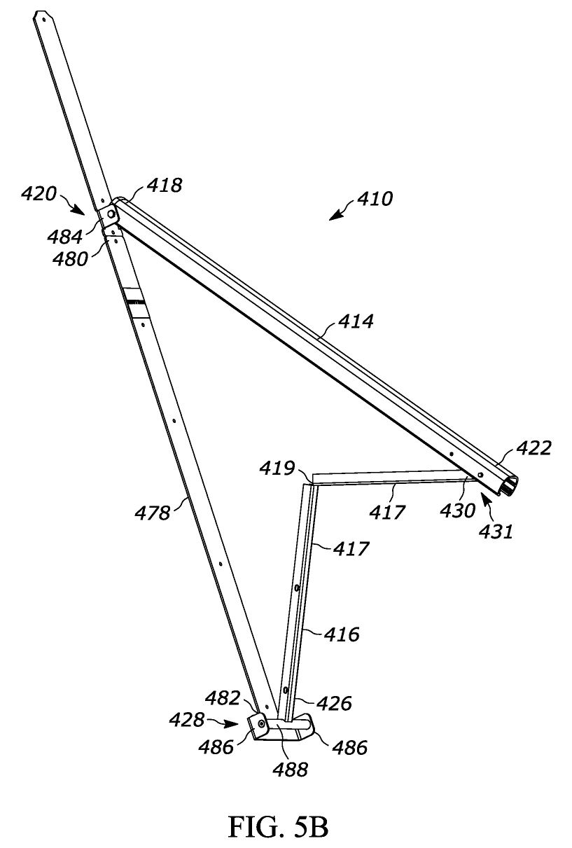

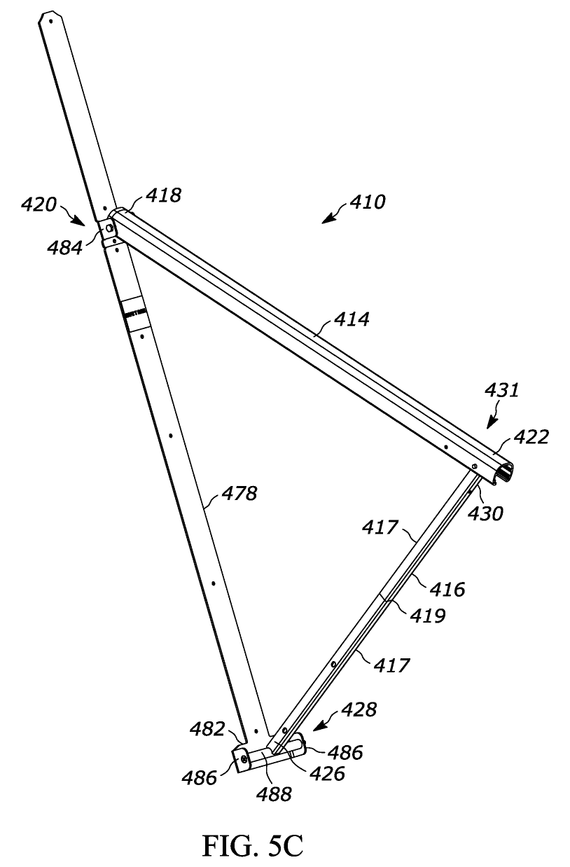

A fifth example collapsible handle 410 for an RV 12 is shown in FIGS. 5A-5C. The collapsible handle 410 includes a handrail 414 and a support arm 416. The handrail 414 has a proximal end 418 pivotably coupled relative to the RV 12 with a first pivot connection 420 and an opposite, distal end 422. This configuration allows the handrail 414 to be pivoted about the pivot connection 420 from a storage position, as shown in FIG. 5A, to a use position, as shown in FIG. 5C. In the storage position, the handrail 414 extends parallel to or generally, e.g., between 0-5 degrees or between 0-3 degrees, parallel to a surface 24 of the RV 12 to which the handle 410 is mounted and, in the use position, the handrail 414 extends outwardly from the surface 24 of the RV 12.

The support arm 416 has a first end 426 pivotably coupled relative to the RV 12 with a second pivot connection 428 and an opposite, second end 430. As shown, the second end 430 of the support arm 416 is pivotably coupled to the distal end 422 of the handrail 414 at a third pivot connection 431. The support arm 416 further includes two portions 417 pivotably coupled together at an intermediate portion of the support arm 416, such as a generally central location as shown. For example, the portions 417 can be coupled together with a hinge 419. The portions 417 are configured to pivot upwardly towards the handrail 414. With this configuration, in the storage position the portions 417 extend along one another behind or within the handrail 414. When use is desired, a user can pull the handrail 414 outwardly, which causes the handrail 414 to pivot about the pivot connection 420 and causes the two portions 417 of the support arm 416 to pivot relative to one another. Further, the lower portion 417 pivots about the second pivot connection 428 and the upper portion 417 pivots about the third pivot connection 431. Eventually the portions 417 are aligned into a straight configuration in the use position to support the handrail 414. The portions 417 can rest on each other, or can include a securing mechanism to hold the portions 417 in the straight, aligned position. The securing mechanism can take any suitable form, such as a clip, fastener, a sleeve, and so forth.

In the illustrated example, in order for the handrail 414 to lie flat along the RV 12 in the storage position, the first and second pivot connections 420, 428 can be spaced from one another a predetermined distance, and the handrail can be sized to be less than the predetermined distance, such that the distal end 422 of handrail 414 is spaced from and disposed adjacent to the second pivot connection 428 in the storage position.

In any of the above, the first and second pivot connections 420, 428 can couple the handrail 414 and support arm 416 directly to structure of the RV 12, such as a wall or frame thereof. For example, the first and second pivot connections can include mounts that are configured to pivotably couple to the proximal end 418 of the handrail 414 and the first end 426 of the support arm 416 and secure to the RV 12 by any suitable mechanism, such as fasteners, welding, adhesive, and so forth.

Alternatively, as shown in the figures, the handle 410 can include a mounting bracket 478 to which the handrail 414 and support arm 416 are pivotably coupled. This allows the handle 410 to be a stand-alone component that can be easily secured in a desired location on the RV 12 while maintaining optimal spacing between the first and second pivot connections 420, 428 given the lengths of the handrail 414 and support arm 416.

As shown, the mounting bracket 478 can include an elongate body with a top portion 480 forming part of the first pivot connection 420 and a bottom portion 482 forming part of the second pivot connection 428. It will be understood that the handrail 414 and support arm 416 can be pivotably mounted to the mounting bracket 478 by any desired methods. Alternatively, the mounting bracket 478 can be split with the top portion 480 and the bottom portion 482 being separate components.

In the illustrated example, the first pivot connection 420 includes a pair of upstanding tabs 484 of the top portion 480 of the mounting bracket 478 that receive the proximal end 418 of the handrail 414 therebetween. A pivot member, such as a pin or rod, couples the tabs 484 to the handrail 414 allowing the handrail 414 to freely pivot relative thereto.

The second pivot connection 428 can have any suitable configuration. In the illustrated example, the bottom portion 482 of the mounting bracket 478 includes a pair of upstanding tabs 486 that receive the first end 426 of the support arm 416 therebetween. A pivot member, such as a pin or rod, couples the tabs 486 to the support arm 416 allowing the support arm 416 to freely pivot relative thereto. If desired, the first end 426 of the support arm 416 can include a bar 488 that extends laterally relative to a longitudinal length of the support arm 416 between the tabs 486. Advantageously, the added width of the bar 488 and the resulting spacing of the tabs 486 and engagement with the bar 488 adds lateral bracing to the support arm 416 and, thus, the handle 410 as a whole. This configuration reduces side-to-side swaying of the handle 410 and allows the handle to provide better support for a person during use. Although the bar 488 is shown extending laterally a generally equal distance on both sides of the support arm 416, the bar 488 can be offset on one side or extend entirely on one side of the support arm 416, as desired. Alternatively, the second pivot connection 428 of this example can have a configuration as set forth in the other examples described herein.

With this configuration, the handrail 414 is able to pivot to the storage position where the handrail 414, support arm 416, and sliding member 432 all extend generally parallel to the mounting bracket 478 and the surface 24 of the RV 12, where the distal end 422 of the handrail 414 is disposed adjacent to and above the second pivot connection 428.

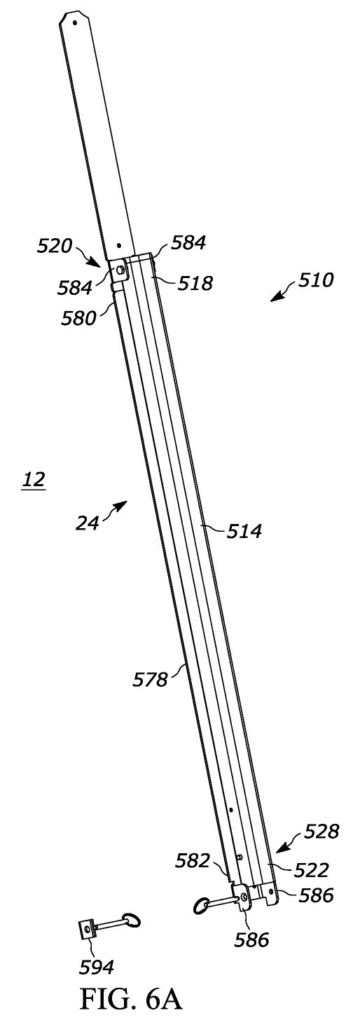

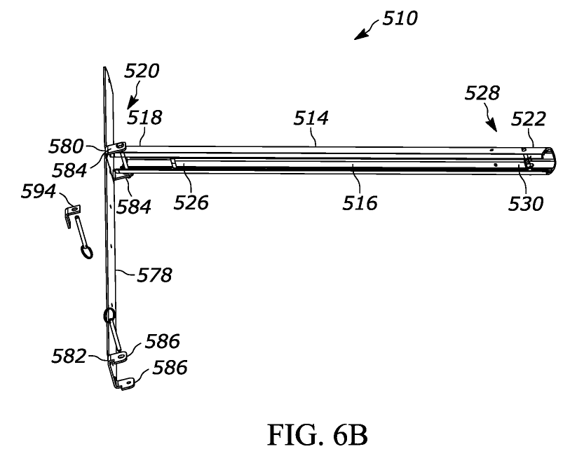

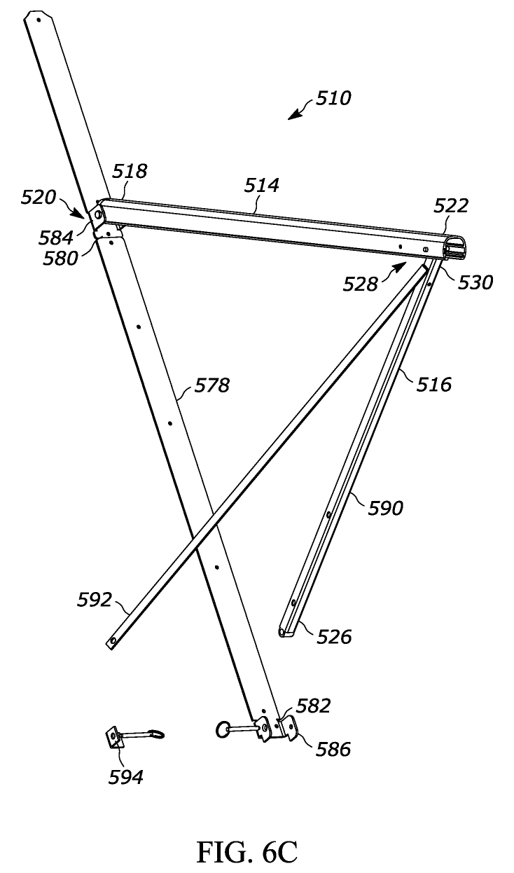

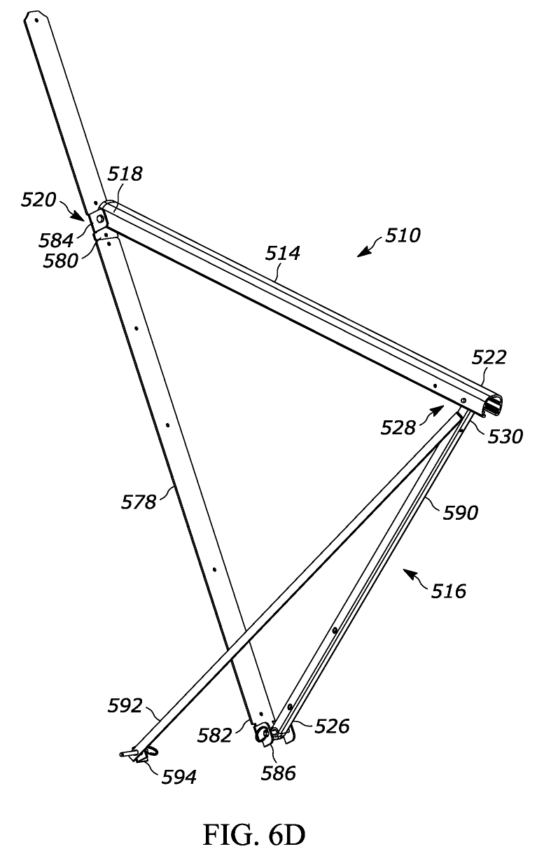

A sixth example collapsible handle 510 for an RV 12 is shown in FIGS. 6A-6D. The collapsible handle 510 includes a handrail 514 and a support arm 516. The handrail 514 has a proximal end 518 pivotably coupled relative to the RV 12 with a first pivot connection 520 and an opposite, distal end 522. This configuration allows the handrail 514 to be pivoted about the pivot connection 520 from a storage position, as shown in FIG. 6A, to a use position, as shown in FIG. 6D. In the storage position, the handrail 514 extends parallel to or generally, e.g., between 0-5 degrees or between 0-3 degrees, parallel to a surface 24 of the RV 12 to which the handle 510 is mounted and, in the use position, the handrail 514 extends outwardly from the surface 24 of the RV 12.

The support arm 516 has a first end 526 and an opposite, second end 530. As shown, the second end 530 of the support arm 516 is pivotably coupled to the distal end 522 of the handrail 514 at a second pivot connection 528. In the storage position, the support arm 516 extends along the handrail 514, such as within a tubular form of the handrail 514. With this configuration, the handrail 514, with the support arm 516 extending therealong, can be pivoted to a use position where the distal end 522 of the handrail 514 is disposed adjacent to the second end 530 of the support arm 516. Thereafter, a user can pivot the support arm 516 downwardly relative to the handrail 514 about the second pivot connection 528 and then secure the first end 530 of the support arm 516 in place relative to the RV 12.

The handrail 514 can be held in the use position and/or the storage position by any desired mechanism. In some examples, the handle 510 can include a lock pin 536 that can be used to selectively engage the handrail 514 and/or support arm 516, or the handrail 514 and/or support arm 516 can include a magnet to hold the handle 510 in a desired position.

In any of the above, the first pivot connection 520 can couple the handrail 514 directly to structure of the RV 12, such as a wall or frame thereof. For example, the first pivot connection can include a mount that is configured to pivotably couple to the proximal end 518 of the handrail 514 and the first end 526 of the support arm 516 and secure to the RV 12 by any suitable mechanism, such as fasteners, welding, adhesive, and so forth.

Alternatively, as shown in the figures, the handle 510 can include a mounting bracket 578 to which the handrail 514 is pivotably coupled. This allows the handle 510 to be a stand-alone component that can be easily secured in a desired location on the RV 12. As shown, the mounting bracket 578 can include an elongate body with a top portion 580 forming part of the first pivot connection 520 and a bottom portion 582. It will be understood that the handrail 514 can be pivotably mounted to the mounting bracket 578 by any desired methods. Alternatively, the mounting bracket 578 can be split with the top portion 580 and the bottom portion 582 being separate components.

In the illustrated example, the first pivot connection 520 includes a pair of upstanding tabs 584 of the top portion 580 of the mounting bracket 578 that receive the proximal end 518 of the handrail 514 therebetween. A pivot member, such as a pin or rod, couples the tabs 584 to the handrail 514 allowing the handrail 514 to freely pivot relative thereto.

The bottom portion 582 of the mounting bracket 578 includes a mount 586 that is configured to be coupled to the first end 526 of the support arm 516 therebetween with a securing mechanism with a securing mechanism. The securing mechanism can take any suitable form, including inserting a pin through aligned openings defined in the ends 522, 530. Alternatively or additionally, the securing mechanism can include a clip, gravity-held coupling, a press-fit coupling, interconnecting structures, and so forth.

In some examples, the support arm 516 includes a main shaft 590 and a leg 592 pivotably coupled to the main shaft 590 at the second end 530 of the support arm 516. With this configuration, the leg 592 can be pivoted outwardly relative to the main shaft 590 to provide lateral bracing for the handle 510. A second mount 594 is secured to the RV to have the leg 592 coupled thereto with a securing mechanism. The securing mechanism can take any suitable form, including inserting a pin through aligned openings defined in the leg 592 and second mount 594. Alternatively or additionally, the securing mechanism can include a clip, gravity-held coupling, a press-fit coupling, interconnecting structures, and so forth. The second mount 594 can be a separate component or can form a portion of the mounting bracket 578.

With this configuration, the handrail 514 is able to pivot to the storage position where the handrail 514 and support arm 516 extend generally parallel to the mounting bracket 578 and the surface 24 of the RV 12, where the distal end 522 of the handrail 514 is disposed adjacent to and above the mount 586.

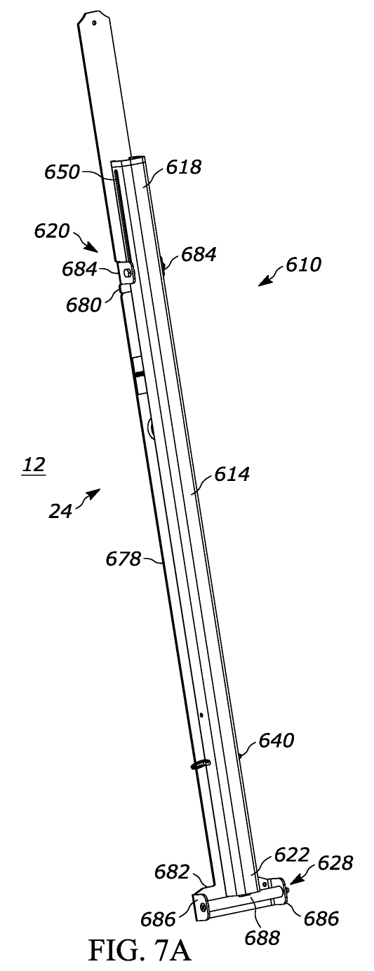

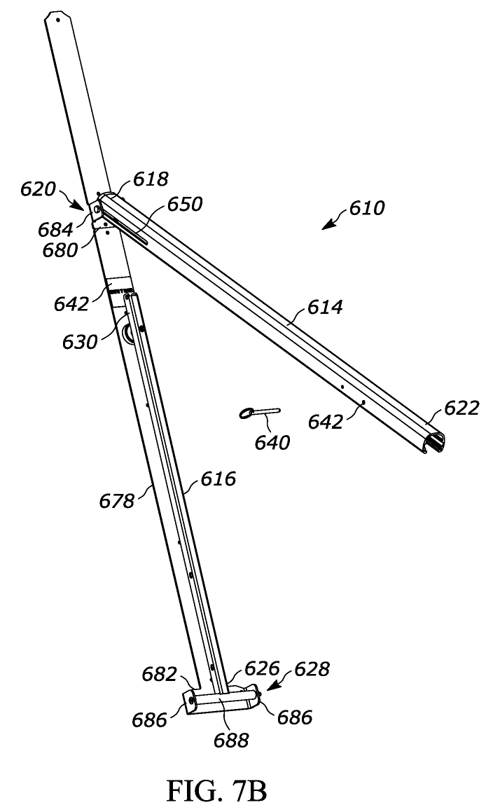

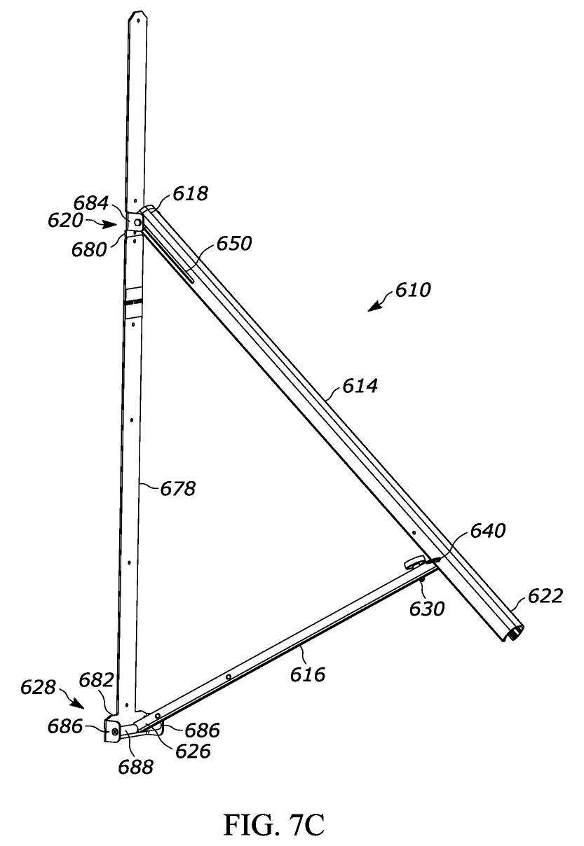

A seventh example collapsible handle 610 for an RV 12 is shown in FIGS. 7A-7C. The collapsible handle 610 includes a handrail 614 and a support arm 616. The handrail 614 has a proximal end 618 pivotably coupled relative to the RV 12 with a first pivot connection 620 and an opposite, distal end 622. This configuration allows the handrail 614 to be pivoted about the pivot connection 620 from a storage position, as shown in FIG. 7A, to a use position, as shown in FIG. 7C. In the storage position, the handrail 614 extends parallel to or generally, e.g., between 0-5 degrees or between 0-3 degrees, parallel to a surface 24 of the RV 12 to which the handle 610 is mounted and, in the use position, the handrail 614 extends outwardly from the surface 24 of the RV 12.

The support arm 616 has a first end 626 pivotably coupled relative to the RV 12 with a second pivot connection 628 and an opposite, second end 630. As shown, the second end 630 of the support arm 616 is configured to be secured to the distal end 622 of the handrail 614. For example, the handrail 614 and the support arm 616 can be pivoted to a use position where the distal end 622 of the handrail 614 is disposed adjacent to the second end 630 of the support arm 616. Thereafter, a user can secure the ends 622, 630 together to hold the handle 610 in the use position. The securing mechanism can take any suitable form, including inserting a pin 640 through aligned openings 642 defined in the ends 622, 630. Alternatively or additionally, the securing mechanism can include a clip, gravity-held coupling, a press-fit coupling, interconnecting structures, and so forth.

In the illustrated example, in order for the handrail 614 to lie flat along the RV 12 in the storage position, the first and second pivot connections 620, 628 can be spaced from one another a predetermined distance, and the handrail can be sized to be less than the predetermined distance, such that the distal end 622 of handrail 614 is spaced from and disposed adjacent to the second pivot connection 628 in the storage position.

In some examples, the first pivot connection 620 and handrail 614 can be configured with a sliding arrangement that provides a longer usable length for the handrail 614 in the use position. The handrail 614 can define a slot opening 650 therethrough to receive the pivot member of the first pivot connection 620 therethrough. With this configuration, as shown in FIG. 7A, the pivot connection 620 can be disposed at a distal end (e.g., bottom when oriented vertically) of the slot opening 650 when the handrail 614 is in the storage position, which allows the distal end 622 to be spaced from and disposed adjacent to the second pivot connection 628. Thereafter, the handrail 614 can be pivoted about the second pivot connection 620 while also being slid outwardly to disposed the second pivot connection at a proximal end of the slot opening 650 as shown in FIG. 7B. Although the handrail 614 is shown with the slot opening 650, in another suitable example, a mounting bracket coupled to the RV 12 can define slot openings 650 to receive a pivot member of the first pivot connection 620 therethrough, such that movement of the handrail 614 between the use and storage positions causes the pivot member to be driven upwardly and downwardly through the slot opening along with movement of the proximal end 618 of the handrail 614.

In any of the above, the first and second pivot connections 620, 628 can couple the handrail 614 and support arm 616 directly to structure of the RV 12, such as a wall or frame thereof. For example, the first and second pivot connections can include mounts that are configured to pivotably couple to the proximal end 618 of the handrail 614 and the first end 626 of the support arm 616 and secure to the RV 12 by any suitable mechanism, such as fasteners, welding, adhesive, and so forth.

Alternatively, as shown in the figures, the handle 610 can include a mounting bracket 678 to which the handrail 614 and support arm 616 are pivotably coupled. This allows the handle 610 to be a stand-alone component that can be easily secured in a desired location on the RV 12 while maintaining optimal spacing between the first and second pivot connections 620, 628 given the lengths of the handrail 614 and support arm 616.

As shown in FIG. 6A, the mounting bracket 678 can include an elongate body with a top portion 680 forming part of the first pivot connection 620 and a bottom portion 682 forming part of the second pivot connection 628. It will be understood that the handrail 614 and support arm 616 can be pivotably mounted to the mounting bracket 678 by any desired methods. Alternatively, the mounting bracket 678 can be split with the top portion 680 and the bottom portion 682 being separate components.

In the illustrated example, the first pivot connection 620 includes a pair of upstanding tabs 684 of the top portion 680 of the mounting bracket 678 that receive the proximal end 618 of the handrail 614 therebetween. A pivot member, such as a pin or rod, couples the tabs 684 to the handrail 614 allowing the handrail 614 to freely pivot relative thereto.

The second pivot connection 628 can have any suitable configuration. In the illustrated example, the bottom portion 682 of the mounting bracket 678 includes a pair of upstanding tabs 686 that receive the first end 626 of the support arm 616 therebetween. A pivot member, such as a pin or rod, couples the tabs 686 to the support arm 616 allowing the support arm 616 to freely pivot relative thereto. If desired, the first end 626 of the support arm 616 can include a bar 688 that extends laterally relative to a longitudinal length of the support arm 616 between the tabs 686. Advantageously, the added width of the bar 688 and the resulting spacing of the tabs 686 and engagement with the bar 688 adds lateral bracing to the support arm 616 and, thus, the handle 610 as a whole. This configuration reduces side-to-side swaying of the handle 610 and allows the handle to provide better support for a person during use. Although the bar 688 is shown extending laterally a generally equal distance on both sides of the support arm 616, the bar 688 can be offset on one side or extend entirely on one side of the support arm 616, as desired. Alternatively, the second pivot connection 628 of this example can have a configuration as set forth in the other examples described herein.

With this configuration, the handrail 614 is able to pivot to the storage position where the handrail 614 and support arm 616 all extend generally parallel to the mounting bracket 678 and the surface 24 of the RV 12, where the distal end 622 of the handrail 614 is disposed adjacent to and above the second pivot connection 628.

In any of the above examples, the handle 10, 110, 210, 310, 410, 510, 610 can include a retention lock configured to hold the handrail 14, 114, 214, 314, 414, 514, 614 and/or the support arm 16, 116, 216, 316, 416, 516, 616 in the storage position. The retention lock can take any suitable form, including a magnet 96, a snap fit coupling, hook and loop fasteners, a cotter pin or the like extending through openings of the handle 10, 110, 210, 310, 410, 510, 610 and support arm 16, 116, 216, 316, 416, 516, 616, and/or other structure of the handle 10, 110, 210, 310, 410, 510, 610 or RV 12, and so forth. In some examples, the magnet 96 is coupled to the support arm 16, 116, 216, 316, 416, 516, 616, such as the second end 30, 130, 230, 330, 430, 530, 630 thereof. The magnet 96 is oriented to magnetically engage the mounting bracket 78, 178, 278, 378, 478, 578, 678 when the support arm 16, 116, 216, 316, 416, 516, 616 is pivoted towards the RV 12 as the handle 10, 110, 210, 310, 410, 510, 610 is returned to the storage position. In examples utilizing a two-piece mounting bracket, a separate mount can be coupled to the RV 12 for the magnet 96 to engage when the handle 10, 110, 210, 310, 410, 510, 610 is in the storage position. Alternatively, the magnet 96 can be configured to engage the RV 12 directly. Other suitable forms can utilize the retention lock at or adjacent to the distal end 22, 122, 222, 322, 422, 522, 622 of the handrail 14, 114, 214, 314, 414, 514, 614 to releasably engage any component of handle 10, 110, 210, 310, 410, 510, 610 and/or RV 12 when the handle 10, 110, 210, 310, 410, 510, 610 is in the storage position.

While several examples have been disclosed herein, any features from any examples may be combined with or replaced by other features from other examples. Moreover, while several examples have been disclosed herein, changes may be made to the disclosed examples without departing from the scope of the claims.

It will be appreciated that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. The same reference numbers may be used to describe like or similar parts.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A handle for a recreational vehicle, the handle comprising:
a handrail having a proximal end and an opposite distal end;
a support arm having a first end and an opposite second end;
a first pivot connection configured to pivotably couple the proximal end of the handrail relative to structure of a recreational vehicle; and
a second pivot connection configured to pivotably couple the first end of the support arm relative to structure of a recreational vehicle,
wherein the second pivot connection comprises:
a pivot mount extending laterally relative to the support arm, the pivot mount having a width to extend past one or both sides of the support arm; and
the first end of the support arm having a pronged configuration with tabs spaced from one another to be pivotably coupled relative to ends of the pivot mount.

2. The handle of claim 1, wherein the pivot mount has an unbroken surface extending between the ends thereof.

3. The handle of claim 1, wherein the pronged configuration of the first end of the support arm further comprises a lateral member that is configured to extend along the pivot mount, the tabs coupled to ends of the lateral member.

4. The handle of claim 3, wherein the pivot mount has an outwardly rounded configuration, the lateral member rotating about the pivot mount when the handrail is moved between storage and use positions.

5. The handle of claim 1, wherein the second end of the support is slidingly coupled relative to the handrail, such that the handrail is configured to be pivoted from a storage position extending along the recreational vehicle and a use position extending outwardly from the recreational vehicle causing the second end of the support arm to slide towards the distal end of the handrail.

6. The handle of claim 5, further comprising a sliding member coupled to the handrail to slide therealong when the handrail is pivoted between the storage and use positions; wherein the support arm is pivotably coupled to the sliding member.

7. The handle of claim 6, further comprising a lock pin configured to restrict movement of the sliding member relative to the handrail to hold the handrail in the use position.

8. The handle of claim 6, wherein a length of the sliding member is configured to extend past the distal end of the handrail with the handrail in the use position to provide an extended handrail.

9. The handle of claim 8, wherein the sliding member is configured to telescope with respect to the handrail.

10. The handle of claim 1, further comprising:
a mounting bracket, the first pivot connection and the second pivot connection including portions of the mounting bracket.

11. The handle of claim 10, further comprising a magnet configured to releasably engage the mounting bracket with the handrail in a storage position.

12. The handle of claim 1, wherein the handrail defines a slot opening configured to receive a pivot member of the first pivot connection therethough, the slot opening allowing the handrail to slide relative to the first pivot connection to extend a useable length of the handrail in the use position.

13. The handle of claim 1, wherein the second end of the support arm is configured to releasably secure to the distal end of the handrail with a lock member.

14. A handle for a recreational vehicle, the handle comprising:
a handrail having a proximal end and an opposite distal end;
a support arm having a first end and an opposite second end;
a first pivot connection configured to pivotably couple the proximal end of the handrail relative to structure of the recreational vehicle; and
a second pivot connection configured to pivotably couple the first end of the support arm relative to structure of the recreational vehicle; and
wherein the handrail and the support arm are configured to be pivoted outwardly to a use position and the second end of the support arm is configured to releasably secure to the distal end of the handrail with a lock member to hold the handle in the use position.

15. The handle of claim 14, wherein the handrail and the support arm have a storage position extending along the structure of the recreational vehicle with the support arm extending along the handrail, the distal end of the handrail configured to releasably secure to the first end of the support arm with a lock member.

16. The handle of claim 14, wherein the second pivot connection comprises a coupling having a width greater than the first end of the support arm.

17. The handle of claim 16, wherein the second pivot connection comprises:
a pivot mount extending laterally relative to the support arm, the pivot mount having a width to extend past one or both sides of the support arm; and
the first end of the support arm having a pronged configuration with tabs spaced from one another to be pivotably coupled relative to ends of the pivot mount.

18. The handle of claim 17, wherein the pivot mount has an unbroken, rounded surface extending between the ends thereof; and the pronged configuration of the first end of the support arm further comprises a lateral member that is configured to extend along unbroken, rounded surface of the pivot mount, the tabs coupled to ends of the lateral member.

19. The handle of claim 14, wherein the second pivot comprises a mount having tabs disposed on either side of the first end of the support arm and a lateral member spanning between the tabs and secured to the first end of the support arm to rotate therewith.

20. The handle of claim 14, further comprising:
a mounting bracket, the first pivot connection and the second pivot connection including portions of the mounting bracket; and
a magnet configured to releasably engage the mounting bracket with the handrail in a storage position.
